(19) United States
(12) Patent Application Publication
(10) Pub. No.: US 2006/0238935 A1
(43) Pub. Date: Oct. 26, 2006

(54) Electrostatic discharge-protected integrated circuit

(76) Inventor: Michael Bernhard Sommer, Raubling (DE)

Correspondence Address: EDELL, SHAPIRO & FINNAN, LLC, 1901 RESEARCH BLVD., SUITE 400, ROCKVILLE, MD, 20850, US

(21) Appl. No.: 11/389,509

(22) Filed: Mar. 27, 2006

Related U.S. Application Data
(63) Continuation of application No. PCT/DE04/02119, filed on Sep. 23, 2004.

(30) Foreign Application Priority Data
Sep. 26, 2003 (DE) DE 103 44 849.7

(51) Int. Cl. H02H 9/00

(52) U.S. Cl. 361/56

(57) ABSTRACT

An electrostatic discharge-protected integrated circuit includes a transistor connected by one of the drain and source terminals to a first terminal that applies a first supply potential and by another of the drain and source terminals to a second terminal that applies a second supply potential. A first capacitor and a second capacitor are connected as a capacitive voltage divider between the first and second terminals. The common coupling node of the first and second capacitors is connected to the control terminal of the transistor. In a discharge mode, the transistor is conductive and thus short-circuits a voltage which is not suitable for normal operation of the functional circuit between the first and second terminals.

### CROSS REFERENCE TO RELATED APPLICATIONS

This application is a continuation of PCT/DE02004/002119, filed Sep. 23, 2004, and titled “Electrostatic Discharge-Protected Integrated Circuit,” which claims priority to German Application No. DE 103 44 849.7, filed on Sep. 26, 2003, and titled “Electrostatic Discharge-Protected Integrated Circuit,” the entire contents of which are hereby incorporated by reference.

### FIELD OF THE INVENTION

The invention relates to an electrostatic discharge-protected integrated circuit.

### BACKGROUND

The electrostatic charge that can be taken up by an individual or person is on the order of magnitude of approximately 0.6 μC. A person can be simulated by a capacitor having the capacitance of 150 pF. If the charge of 0.6 μC is stored on a capacitor having the capacitance of 150 pF, then this corresponds to a charging voltage of approximately 4 kV. If a person who has been charged to such a voltage touches a grounded object, an electrostatic discharge occurs. The latter proceeds in approximately 0.1 μs with currents of up to several amperes.

Owing to the small oxide thickness and the small dimensions of the interconnects and pn junctions, electrostatic discharge processes proceeding via MOS (=Metal Oxide Semiconductor) components generally lead to the destruction of the device. The discharge processes primarily lead to the breakdown of the gate oxide or else to the overheating of pn junctions or interconnects. The energy converted during an electrostatic discharge is generally on the order of magnitude of 0.1 mJ and is therefore not very high. However, if this energy is fed in pulsed fashion into a volume of the order of magnitude of a few cubic micrometers, then this can give rise locally to such a high temperature that the silicon melts. Electrostatic discharge or ESD protection circuits should therefore be connected between the supply voltage terminals. The ESD protection circuits should have high resistance for input voltages that lie within the specification and should have low resistance for voltages that lie outside the specification and, in particular, in the ESD range.

In a known circuit arrangement for protecting integrated circuits against electrostatic discharge, protection diodes are used. The cathode terminal of the diode is connected to a supply voltage terminal and the anode terminal is connected to a terminal for the reference potential. If positive voltages that lie outside the specification occur at the reference potential terminal, then the diode is forward-biased and dissipates the positive electrostatic charge to the positive supply voltage terminal.

The use of a protection diode connected in this manner has the disadvantage that the diode cannot be operated in the on-state range when high negative voltages occur at the terminal for the reference potential. The discharge would instead lead in the blocking range to a breakdown and thus generally to the destruction of the diode. Consequently, a high negative charge cannot be dissipated from the terminal for the reference potential to the supply voltage terminal. Reversing the polarity of the diode is not appropriate since a diode connected in this manner would lead to a short circuit between the supply potential terminal and the reference potential terminal.

One conceivable solution to this problem is to use zener diodes, the latter are connected to the reference potential terminal by their anode terminal and to the positive supply potential terminal by their cathode terminal. In the event of a specific negative voltage at the anode terminal, the known zener breakdown of the diode occurs, so that a high negative voltage can be dissipated to the positive supply potential terminal. One disadvantage of using zener diodes is the high production costs.

A further known variant of an ESD circuit is the use of a capacitor connected for example between the supply potential terminal and the reference potential terminal. When a high electrostatic voltage occurs between the supply potential terminal and the reference potential terminal, then only a small voltage is dropped across the capacitor. A prerequisite for this is that the capacitor has a high capacitance. The realization of high capacitances has the disadvantage that this necessitates a large space requirement in terms of chip area, which is at odds with the requirement for increasing miniaturization of devices.

U.S. Pat. No. 6,172,861 describes a circuit arrangement for electrostatic discharge protection, in which a MISFET (metal-insulator-semiconductor field effect transistor) is connected by its source terminal to a terminal pad for application of control signals and by its drain terminal to a terminal for application of a reference potential. The substrate terminal of the MISFET is connected to its source terminal. The gate terminal of the MISFET is connected via a gate resistance to a terminal for application of a negative supply voltage. When a positive electrostatic charge occurs at the terminal pad the controllable drain-source path of the MISFET is operated in the forward direction, whereas when a negative electrostatic charge occurs at the terminal pad, the controllable path of the MISFET becomes conducting if the negative voltage exceeds the breakdown voltage of the MISFET. A circuit component of an integrated circuit can thus be protected against positive and negative electrostatic charge by connecting a single MISFET transistor upstream.

### SUMMARY

The present invention provides a cost-effective and space-saving electrostatic discharge-protected integrated circuit.

In accordance with the present invention, an electrostatic discharge-protected integrated circuit comprises a terminal to apply a first supply potential, a terminal to apply a second supply potential, a terminal to process a digital signal, a transistor comprising a source terminal, a drain terminal and a control input to apply a control voltage, a first capacitor, a second capacitor, a resistor, and a functional circuit containing logic gates and memory cells. The transistor is connected by one of the drain and source terminals to the terminal that applies the first supply potential and by another of the drain and source terminals to the terminal that applies the second supply potential. The first capacitor is connected between the terminal that applies the first supply potential and the control input of the transistor. The second capacitor is connected between the control input of the transistor and the terminal that applies the second supply potential.

The resistor is connected between the control input of the transistor and the terminal that applies the second supply potential. The functional circuit is connected to the terminal that applies the first supply potential, the terminal that applies the second supply potential and a terminal to read data in and out. The functional circuit carries out a digital signal processing in the normal operating mode, with a supply voltage being fed via the terminal for application of a first supply potential and via the terminal for application of a second supply potential.

In one embodiment of the invention, the first capacitor is formed by an overlap capacitor formed between the drain or source terminal and the control input of the transistor. This has the advantage that a separate component need not be provided for the first capacitor and chip area is not unnecessarily taken up thereby.

In a further embodiment of the invention, the transistor is switched into the conductive state in the discharge case. It is nonconductive in the normal operating mode of the functional circuit. This prevents the occurrence of a discharge via the transistor upon application of the supply voltage that is required for normal operation of the functional circuit.

In still another embodiment of the invention, the resistance and a total capacitance are dimensioned such that the product of the resistance and the total capacitance is greater than 150 ns. The total capacitance is formed from the series circuit comprising the first capacitor with the parallel circuit comprising the second capacitor with a capacitance assigned to the control input of the transistor.

The capacitance assigned to the control input of the transistor comprises a gate-source capacitor, a gate-drain capacitor, a gate-substrate capacitor, and also a gate-source overlap capacitor and a gate-drain overlap capacitor. The gate-source capacitor forms as a result of the different doping between the source region and the region below the gate terminal. The gate-drain capacitor forms as a result of the different doping between the drain region and the region below the gate terminal. The gate-substrate capacitor forms between the gate terminal and the substrate. The gate-source overlap capacitor forms in a region in which the source region lies below the gate contact. The gate-drain overlap capacitor forms in a region in which the drain region lies below the gate contact.

In a further embodiment of the invention, the functional circuit comprises a random access memory in which memory cells are connected in each case to a word line and a bit line, for example a DRAM memory. A memory cell of the functional circuit is selected by addresses supplied to a terminal of the functional circuit.

In one embodiment of the invention, the transistor is an n-channel field effect, transistor.

In a further embodiment of the invention, the terminal that applies the first supply potential is connected to a positive supply potential of a supply voltage.

In another embodiment of the invention, the terminal that applies the second supply potential is connected to a reference potential of the supply voltage.

The above and still further features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 shows an integrated circuit of a semiconductor memory with an ESD protection circuit in accordance with the invention.

FIG. 2 shows a cross section through a transistor of the ESD protection circuit in accordance with the invention.

FIG. 3 shows a circuit arrangement for testing an electronic device for ESD compatibility according to the human body model in accordance with the invention.

FIG. 4 shows a circuit arrangement with which the function of a circuit for electrostatic discharge protection is tested in accordance with the invention.

FIG. 5 shows diagrams depicting a simulation of a current/voltage diagram of the circuit for ESD protection according to the invention upon application of a short voltage pulse.

FIG. 6 shows diagrams depicting a simulation of a current/voltage diagram of the circuit for ESD protection according to the invention upon application of a long voltage pulse.

FIG. 7 shows diagrams depicting a simulation of a current/voltage diagram of the circuit for ESD protection according to the invention upon application of the supply voltage.

### DETAILED DESCRIPTION

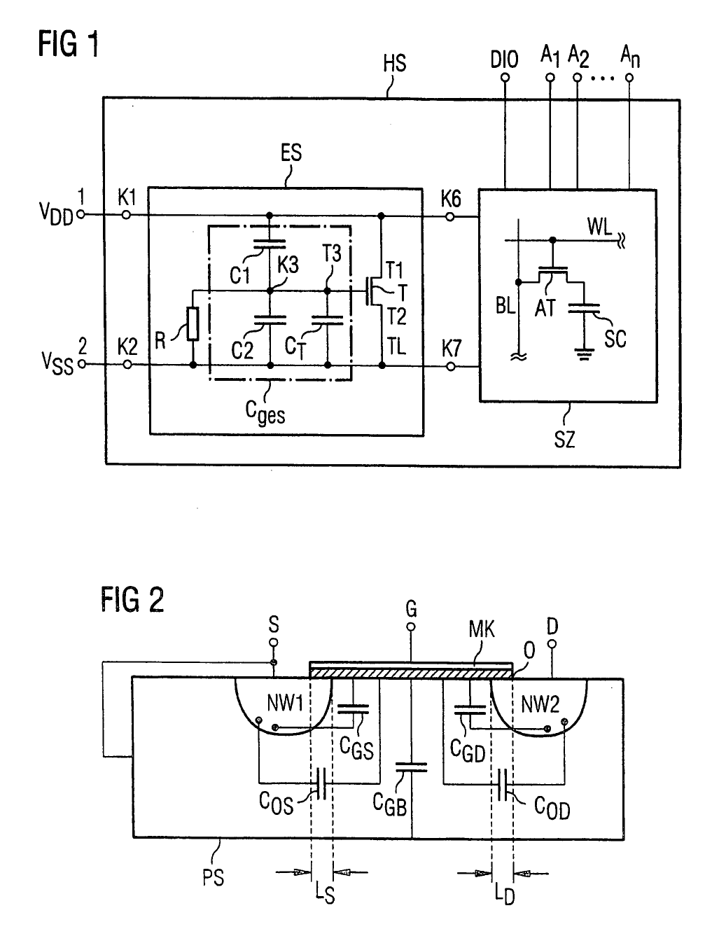

FIG. 1 shows a semiconductor memory HS containing an integrated circuit component for electrostatic discharge protection ES and a memory cell array SZ. The integrated circuit component for electrostatic discharge protection ES is connected via an input terminal K1 to a terminal 1 for application of a supply potential V_{DD} and via an input terminal K2 to a terminal 2 for application of a supply potential V_{SS}. On the output side, it is connected to the memory cell array SZ via a terminal K6 and a terminal K7. The integrated circuit component for electrostatic discharge protection ES connects the input terminal K1 to the output terminal K6 and the input terminal K2 to the output terminal K7. A transistor T is connected to the terminal K1 by one of its drain and source terminals T1 and to the terminal K2 by the other of the drain and source terminals T2. A control input T3 of the transistor is connected to a node K3. A first capacitor C1 connects the node K1 to the node K3. A second capacitor C2 connects the node K3 to the node K2. The node K3 is additionally connected to the node K2 via a resistor R. A capacitor C_{T} is depicted at the control input of the transistor T, and this capacitor connects the control input of the transistor T to the node K2. The capacitor C_{T} comprises the capacitances that are effective at the gate. These capacitances are explained below with reference to FIG. 2.

If a voltage applied between the terminals 1 and 2 occurs which lies outside the voltages specified for normal operation of the memory cell array, then an electrostatic discharge occurs. The circuit is dimensioned such that, in the event of said discharge, the transistor is switched into the conductive state and produces a low-resistance connection between the terminals 1 and 2 via the transistor line TL.

The memory cell array SZ is connected to a terminal K6 for application of a first supply potential V_{DD}, a terminal K7 for application of a second supply potential V_{SS}, a terminal DIO for reading data in and out, and to terminals A1, A2, . . . , An for application of addresses. The memory cell array contains DRAM memory cells, each of which is connected to a word line WL and a bit line BL. For reasons of improved clarity, the memory cell array illustrated in FIG. 1 contains only one DRAM memory cell. The latter comprises a selection transistor AT and a storage capacitor SC. The selection transistor AT is connected between the bit line BL and the storage capacitor SC. If the selection transistor is switched into the conductive state by a control signal on the word line, then it acts like a closed switch which connects the storage capacitor SC to the bit line BL. The storage capacitor can then be accessed in reading or writing fashion. If the logic state 1, for example, is stored in the memory cell then the capacitor is discharged during the read-out of the memory cell, so that a discharge current flows on the bit line. In the opposite case, when writing the logic state I to the memory cell, the capacitor is charged by a charging current flowing on the bit line. In order to operate the memory cell array normally as intended, for example in order to be able to effect reading and writing access, the transistor T must be in the nonconductive state and the first supply voltage V_{DD} must be present at the terminal K6 of the memory cell array and the second supply voltage V_{SS} must be present at the terminal K7 of the memory cell array.

FIG. 2 shows the cross section through the transistor T described in FIG. 1. A first n-doped region NW1 and a second n-doped region NW2 are arranged in a p-doped substrate PS. The first region NW1 is connected to a source terminal S. The second region NW2 is connected to a drain terminal D. A contact MK is connected to the gate terminal G and insulated from the p-doped substrate PS by a gate oxide layer O. The first n-doped region NW1 partially lies below the metalized gate contact MK. The length of the source-side overlap region is identified by L_{S}. The second n-doped region NW2 likewise partially lies below the metalized gate contact MK. The length of the drain-side overlap region is identified by L_{D}. FIG. 2 depicts the capacitors which form between the metalized gate contact MK and the above-described n- and p-doped regions of the transistor. The capacitors are specifically a gate-substrate capacitor C_{GB}, which forms between the metallized gate contact and the p-doped substrate PS. Added to this are a gate-source capacitor C_{GS}, which forms between the metalized gate contact MK and the source region NW1, and a gate-drain capacitor C_{GD}, which forms between the metalized gate contact MK and the drain region NW2. The overlap capacitor C_{OS} arises in the region L_{S} in which the first n-doped region NW1 overlaps the metalized gate contact MK. The overlap capacitor C_{OD} arises in the region L_{D} in which the second n-doped region NW2 overlaps the metalized gate contact MK.

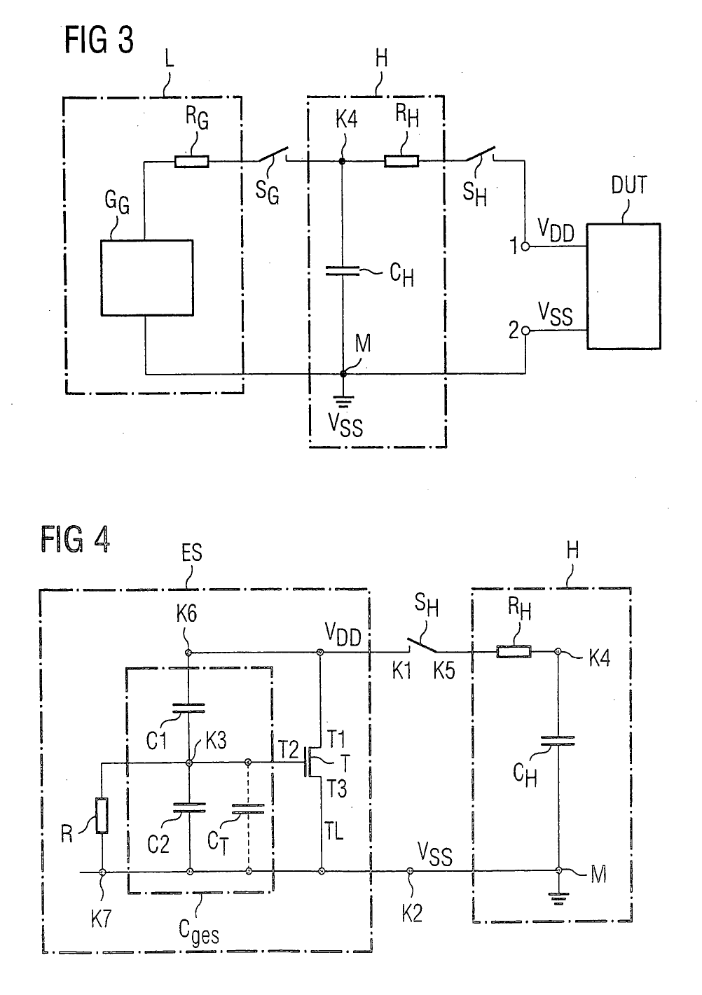

FIG. 3 shows a circuit arrangement for checking the ESD strength of an electronic device DUT (device under test), for example of the semiconductor memory circuit HS from FIG. 1, according to the so-called human body model. The circuit arrangement includes a subcircuit L containing a voltage generator G_{G} and a resistor R_{G}, and a subcircuit H containing a capacitor C_{H} and a resistor R_{H}. The generator G_{G} is connected to a switch S_{G} via the resistor R_{G}. The resistor can be connected to the first terminal K4 of a capacitor C_{H} via the switch S_{G}. The capacitor C_{H} is connected to a reference potential V_{SS} via a second terminal M. In the human body model, the capacitor C_{H} simulates a person carrying an electrostatic charge and has a value of 150 pF. The terminal K4 of the capacitor C_{H} is connected to a switch S_{H} via a resistor R_{H}. In the human body model, the resistor R_{H} represents a discharge resistance, for example the skin resistance, and has a value of 1.5 kΩ. The electronic device DUT that is to be checked with regard to ESD strength is connected to the switch S_{H} via a terminal 1 for application of a first supply potential VDD and to the terminal M via a terminal 2 for application of a second supply potential V_{SS}.

The above-described circuit arrangement according to the human body model is used to test whether an integrated circuit withstands a discharge of at least 2 kV undamaged with regard to the supply terminals. The devices are tested in two cycles. During the first cycle, the switch S_{G} is closed and the switch S_{H} is open. The generator G_{G} subsequently charges the capacitor C_{H} to a voltage of 2 kV via the resistor R_{G}. In the second test cycle, the switch S_{L} is opened again and the switch S_{H} is closed. The supply terminals of the device DUT are then connected via the resistor R_{H} to the capacitor that has been charged to 2 kV. The capacitor is discharged after approximately 1 μs. During a functional test that is subsequently to be carried out, it is investigated whether the device has withstood the discharge process undamaged.

FIG. 4 shows a circuit arrangement with which the function of the circuit ES described in FIG. 1 can be tested. The circuit ES for electrostatic discharge protection includes a first terminal K1 for application of a first supply potential V_{DD} and a second terminal K2 for application of a second supply potential V_{SS}. A transistor T is connected to the terminal K1 by one of its drain and source terminals T1 and to the terminal K2 by the other of the drain and source terminals T2. A control input T3 of the transistor is connected to a node K3. A first capacitor C1 connects the node K1 to the node K3. A second capacitor C2 connects the node K3 to the node K2. The node K3 is additionally connected to the node K2 via a resistor R. A capacitor C_{T} is depicted in dashed fashion at the control input of the transistor T, which capacitor connects the control input of the transistor T to the node K2. The capacitor C_{T} combines the gate capacitors described in the embodiment of FIG. 2. The node K1 can be connected via a switch S_{H} to a resistor R_{H} of the subcircuit in FIG. 3. The subcircuit H includes a capacitor C_{H} connected to the resistance R_{H} by a first terminal K4 and to a reference potential V_{SS} by a second terminal M.

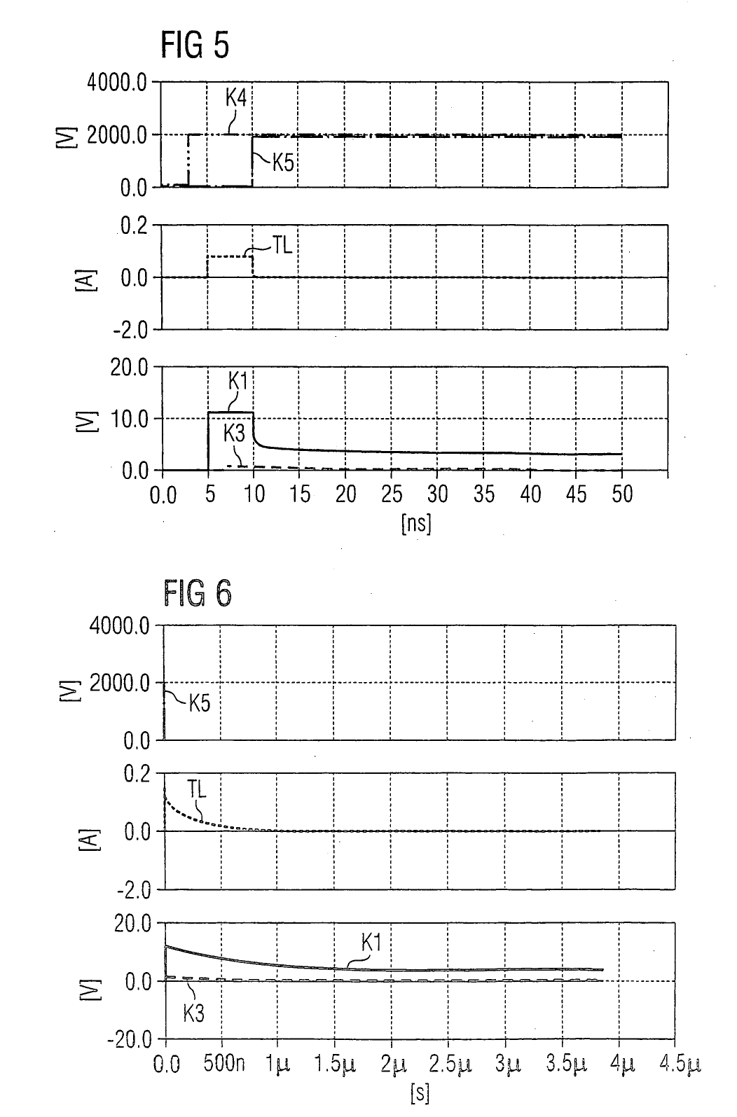

In order to check the ESD strength of an electronic device, controlled discharges are carried out in the human body model. For this purpose, the capacitor C_{H} is charged to a charge of 2 kV. If the switch S_{H} is closed, then the capacitor is discharged via the electronic device containing the circuit ES. The protection circuit ES prevents the discharge current from destroying the circuit components integrated in the electronic device. The diagrams of FIGS. 6, 7 and 8 will be consulted for more precise consideration of the functioning of the protection circuit ES. The nodes and lines designated in the diagrams can be gathered from FIG. 5.

FIG. 5 illustrates three diagrams that are used to elucidate the behavior of the circuit ES upon application of a short voltage surge. The short voltage surge is characterized in that the switch S_{H} is closed for a time period of 5 ns and is subsequently opened again. The first (i.e., top) diagram of FIG. 5 describes the potential profile at the node K4 and at the node K5. The second (i.e., middle) diagram of FIG. 5 shows the profile of the current in the transistor branch TL. The third (i.e., bottom) diagram of FIG. 5 illustrates the potential profile at the node K1 and K3. The simulation time period in the three diagrams extends from 0 to 55 ns. After a delay time of 3 ns, the capacitor C_{H} is charged to a voltage of 2 kV. The switch S_{H} is open until the instance 5 ns. A potential of 2 kV is therefore established at the node K4 and at the node K5. After 5 ns have elapsed, the switch S_{H} is closed.

The third diagram of FIG. 5 shows that a voltage of approximately 0.5 V is established via the voltage divider formed from the capacitance C1 and C2 at the control input K3 of the transistor. This control voltage suffices to switch the transistor T into the conductive state. The second diagram of FIG. 5 shows that a partial current of approximately 0.12 A flows in the transistor line TL. A further partial current, not depicted in this diagram, flows away via the substrate. Due to the large scale of the voltage axis from 0 to 4000 V, the potential illustrated in the first diagram of FIG. 5 at the node K5 coincides with the time axis for the time period in which the switch S_{H} is closed. Since the potential at the node K5 with switch S_{H} closed is identical to the potential present at the node K1, however, the precise value can be gathered from the third diagram. As can be seen from the third diagram of FIG. 5, the voltage at the node K1 drops to a value of approximately 11 V owing to the current flow through the conducting transistor. Only a reduced stress voltage of approximately 11 V is thus present between the terminals K1 and K2 of the protection circuit ES. At the instant 10 ns, the switch S_{H} is opened again.

The first diagram of FIG. 5 shows a jump in the potential at the node K5 to the potential brought about by the charge of the capacitor C_{H} at the node K4. The third diagram shows that the potential present at the node K1 decreases from 11 V to approximately 5 V. The capacitor C1 can still momentarily be discharged via the transistor branch TL until the transistor undergoes transition to the off state as a result of the reduction of the potential at the node K3 and, apart from small leakage currents, no more current flows in the transistor branch. The charge which remains on the capacitor C1 and brings about a residual potential of approximately 5 V at the node K1 is then discharged via the resistor R and via leakage currents of the transistor.

FIG. 6 illustrates three diagrams that are used to elucidate the behavior of the circuit ES upon application of a long voltage surge. The long voltage surge is characterized in that the switch S_{H} is closed for a time period of more than 4.5 μs. The first (i.e., top) diagram of FIG. 6 describes the potential profile at the node K5. The second (i.e., middle) diagram of FIG. 6 shows the profile of the current in the transistor branch TL. The third (i.e., bottom) diagram of FIG. 6 illustrates the potential profile at the node K1 and K3. The simulation time period in the three diagrams extends from 0 to 4.5 μs. As shown in the first diagram, a potential of 2 kV is present at the node K5 prior to the closing of the switch S_{H}, said potential being brought about by the charge stored on the capacitor C_{H}. After the closing of the switch S_{H}, the potential at the node K5 corresponds to the potential at the node K1. Due to the more suitable scale, the profile of this potential is elucidated in the third diagram of FIG. 6. After the closing of the switch S_{H}, a potential of approximately 0.5 V arises at the node K3 of the capacitive voltage divider formed from the capacitors C1 and C2. This potential acts on the control input T3 of the transistor and switches the transistor into the conductive state. The transistor branch TL has acquired low resistance, so that the capacitor C_{H} can be discharged. The total charge has flowed away after approximately 1 μs.

The second diagram of FIG. 6 reveals the exponential decrease in the current in the branch TL from 0.12 A at the instant when the switch S_{H} is closed down to a small residual current after 1 μs has elapsed. The potential at the node K1 and at the node K3 likewise decreases after the closing of the switch S_{H}. The capacitors of the capacitive voltage divider are discharged via the resistor R and via leakage currents of the transistor. If the requirement according to which the product of the resistance R and a total capacitance Cₜₒₜ, which is composed of the series circuit including the first capacitor C1 with the parallel circuit including the second capacitor C2 with the gate capacitors of the transistor, is to be less than 150 ns is complied with, then the transistor remains in the conductive state until the entire charge stored on the capacitor C_{H} has flowed away. The function of the circuit component ES from FIG. 1 corresponds appropriately and the dimensioning requirement made of the resistor R and the total capacitance Cₜₒₜ also holds true for the corresponding elements from FIG. 1. The closing of the switch S_{H} corresponds here to the terminal 1 being touched by a person carrying an electrostatic charge.

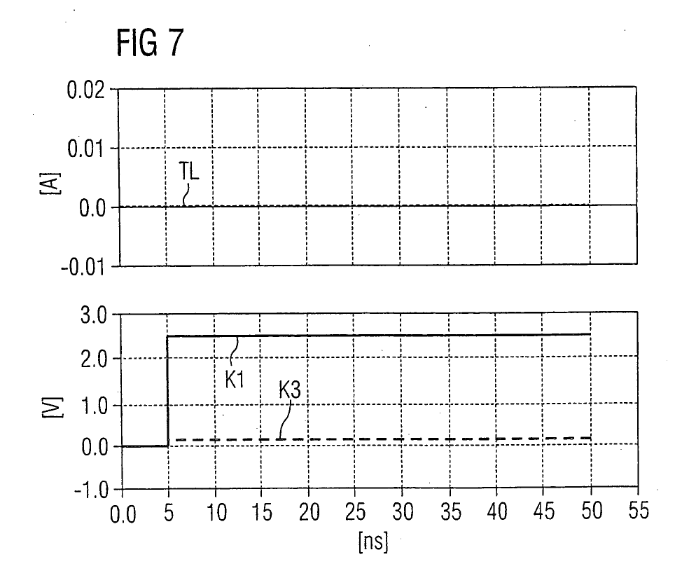

FIG. 7 illustrates two diagrams illustrating the behavior of the circuit ES upon application of the supply voltage between the terminals K1 and K2 from FIG. 5. The supply voltage of a semiconductor memory is generally 2.5 V. A simulation time period from 0 to 55 ns is plotted. The first (i.e., top) diagram of FIG. 7 shows the current profile in the transistor branch TL. The second (i.e., bottom) diagram of FIG. 7 shows the voltage profile at the node K1 and at the node K3. The switch S_{H} is closed after 5 ns. A needle-shaped current pulse can be discerned in the first diagram at this instant. Said current pulse arises since the capacitors represent a short circuit at the first moment of the closing of the switch S_{H}. The transistor momentarily becomes conductive. As soon as the capacitors C1 and C2 have been charged by the current flow, they represent in infinite resistance. The supply potential of 2.5 V is then present at the node 1 and a voltage of approximately 0.3 V is present at the node K3. This voltage at the control input of the transistor does not suffice to switch the transistor into the conductive state. As a result, the supply voltage is not short-circuited via the transistor branch, but rather is available for operating a functional circuit connected between the output terminals K6 and K7, for example a DRAM memory cell array.

While the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

### List of Reference Symbols

HS Semiconductor memory
ES Circuit for electrostatic discharge protection
SZ Memory cell array
K Terminal
V_{DD} First supply potential
V_{SS} Second supply potential
T Transistor
T1 Source terminal of the transistor
T2 Drain terminal of the transistor
T3 Gate terminal of the transistor
C1 First capacitance
C2 Second capacitance
R Resistor
C_{T} Gate capacitances of the transistor
TL Transistor line
DIO Terminal for data
A Terminal for addresses
WL Word line
BL Bit line
AT Selection transistor
SC Storage capacitor
PS p-doped substrate
NW n-doped region within the substrate PS
S Source terminal
G Gate terminal
D Drain terminal
MK Metalized contact

O Oxide layer
L_{S} Source-side overlap region
L_{D} Drain-side overlap region
C_{GS} Gate-source capacitance
C_{GD} Gate-drain capacitance
C_{GB} Gate-substrate capacitance
C_{OS} Source-side overlap capacitance
C_{OD} Drain-side overlap capacitance
G First subcircuit of the human body model
H Second subcircuit of the human body model
G_{G} Voltage generator
R_{G} Resistor
C_{H} Capacitance
R_{H} Resistor
S Switch
M Reference potential terminal

What is claimed is:

1. An electrostatic discharge-protected integrated circuit comprising:
a first terminal that applies a first supply potential;
a second terminal that applies a second supply potential;
a terminal that reads data in and out of integrated circuit;
a transistor comprising a source terminal, a drain terminal and a control input that applies a control voltage, wherein the transistor is connected by one of the drain and source terminals to the first terminal and by the other of the drain and source terminals to the second terminal;
a first capacitor connected between the first terminal and the control input of the transistor;
a second capacitor connected between the control input of the transistor and the second terminal;
a resistor connected between the control input of the transistor and the second terminal; and
a functional circuit comprising logic gates and memory cells, wherein the functional circuit is connected to the first terminal, the second terminal and the terminal that reads data in and out, and the functional circuit carries out digital signal processing in a normal operating mode with a supply voltage being fed via the first and second terminals.

2. The integrated circuit of claim 1, wherein the first capacitor is formed by an overlap capacitor formed between the drain terminal or source terminal and the control input of the transistor.

3. The integrated circuit of claim 1, wherein the transistor is switched into a conductive state when being discharged, and the transistor is nonconductive in the normal operating mode of the functional circuit.

4. The integrated circuit of claim 1, further comprising a total capacitor formed from a series circuit including the first capacitor with a parallel circuit including the second capacitor and a capacitor assigned to the control input of the transistor, wherein the total capacitor and the resistor are dimensioned such that the product of the resistance of the resistor and the capacitance of the total capacitor is greater than 150 ns.

5. The integrated circuit of claim 1, wherein the functional circuit comprises a random access memory device including memory cells, with each memory cell connected to a word line and a bit line, and each memory cell is accessible via a terminal that applies an address signal.

6. The integrated circuit of claim 1, wherein the transistor comprises an n-channel field effect transistor.

7. The integrated circuit of claim 4, wherein the capacitor assigned to the control input of the transistor comprises:
a gate-source capacitor that is formed as a result of different doping between the source region and a region below a gate terminal;
a gate-drain capacitor that is formed as a result of different doping between the drain region and the region below the gate terminal;
a gate-substrate capacitor that is formed between the gate terminal and the substrate;
a gate-source overlap capacitor that is formed in a region of the source region that lies below a gate contact; and
a gate-drain overlap capacitor that is formed in a region in which the drain region lies below the gate contact.

8. The integrated circuit of claim 1, wherein the first terminal applies a positive supply potential of a supply voltage.

9. The integrated circuit of claim 1, wherein the second terminal applies a reference potential of the supply voltage.
